(19) United States
(12) Patent Application Publication
(10) Pub. No.: US 2010/0229773 A1
(43) Pub. Date: Sep. 16, 2010

(54) Method and Template for Creating Hexagon Patterns in Quilting

(76) Inventor: Karl William Droese, Big Bend, WI (US)

Correspondence Address: KARL W. DROESE, S99 W24280 FOREST HOME AVE., BIG BEND, WI, 53103, US

(21) Appl. No.: 12/400,796

(22) Filed: Mar. 10, 2009

(51) Int. Cl. D05B 11/00; B43L 13/20

(52) U.S. Cl. 112/475.08; 33/565

(57) ABSTRACT

A method is described using paired templates for simplifying the design and construction of a hexagon based quilt top. This method overcomes the inherent difficulty in traditional hexagon quilting. In order to sew individual hexagons together and have them lie in a plane, the seam that connects each edge must stop short of running the entire length of that edge by the width of the seam on the adjacent edge at each end. A method is described that allows for continuous stitch lines without having to precisely start and stop stitching. It employs a shape within a shape concept, allowing a hexagon to fit inside a triangle which lends itself to sewing together using easier stitching techniques. The hexagon is sized to precisely fit inside an equilateral triangle and the tips of the triangles that fall outside of the hexagon shape, themselves come together to form a hexagon when the triangles are joined together. A variation of this method allows the original hexagon shapes to be joined at the points rather than the sides to allow greater flexibility in the final quilt design.

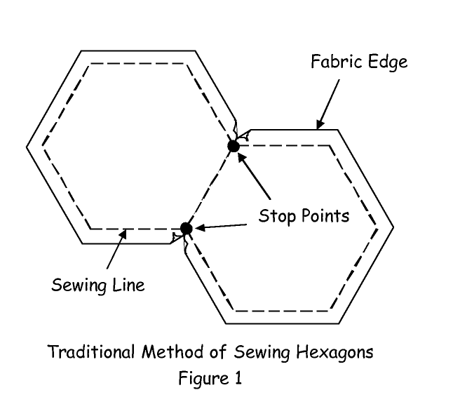

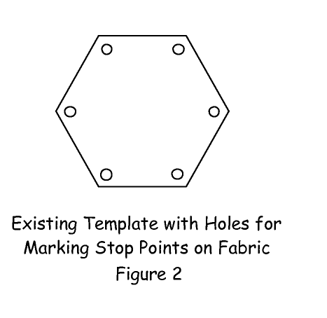

The current methods for creating a quilt top using hexagon pieces are difficult and time consuming to apply. The inherent difficulty with sewing together hexagon pieces is the lack of a straight, continuous line for stitching. In order for the finished product to remain in one plane, the stitching must stop short of the intersection of the next seamed border, by the amount of the seam itself. See FIG. 1. Prior art includes methods and templates designed to facilitate marking the location where the stitching is to stop and start. For example, there exists a template that is used as a cutting guide for a hexagon piece which also provides holes for marking the start and stop point for stitching. See FIG. 2.

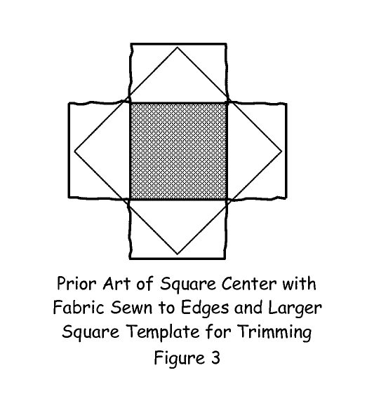

Prior art for square quilting techniques include the use of multiple templates that are utilized in stages. For example, a simple square can be cut out using a template or ruler, and then additional pieces of material are sewn to the four edges of the square. A second, larger template can be placed over the composite and a new outer shape created. See FIG. 3. This process can be repeated innumerable times.

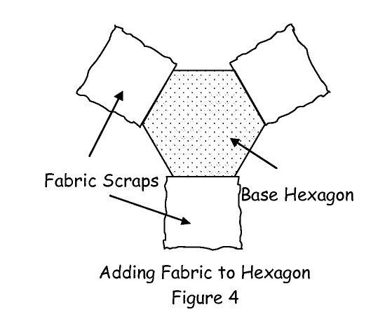

Using the concept of multiple, sequential templates to create a shape within a shape, a new method is created for making a quilt design incorporating hexagon shapes. The initial template is in the shape of a hexagon. Three scraps of material are then sewn on to the three non-consecutive sides of the hexagon. See FIG. 4. The three scraps are of sufficient size so that when combined with the starting hexagon, they completely fill the area under the second template which is an equilateral triangle.

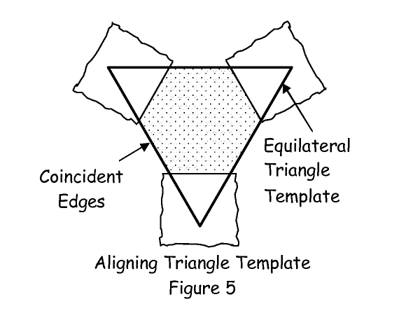

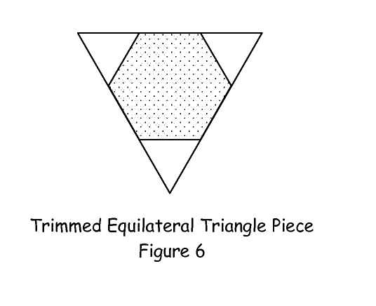

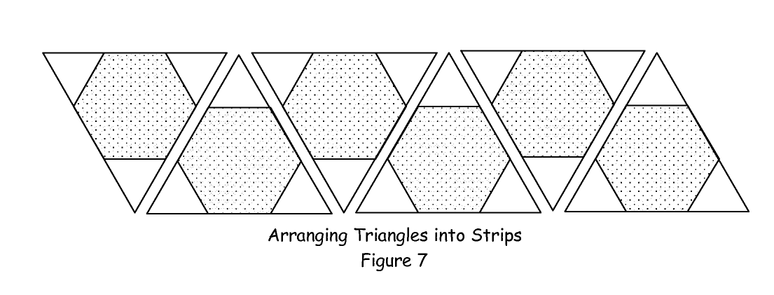

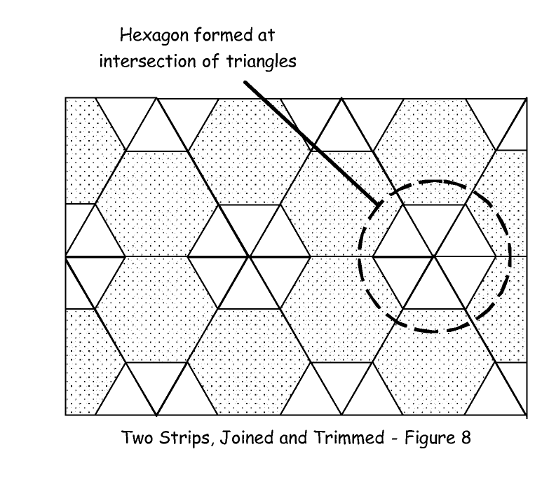

The templates are sized so that the three non-continuous sides of the hexagon template are coincident with the central portion of each of the three sides of the equilateral triangle template. See FIG. 5. This will be referred to as paired templates. When the sewn fabric unit is cut using the second template, the resulting piece is a large triangle with the original hexagon shape in the center and three smaller triangles attached to it. See FIG. 6. By creating multiple triangular pieces and orienting them in alternating, opposite directions, a series of straight seams will join the pieces to form a strip. The strips can then be sewn together using straight and continuous stitching to form the quilt top. See FIG. 7. The resulting pattern will be a multitude of hexagons. Some are products of the original hexagon template and the others will be formed by the joining of 6 smaller triangles at the intersections. See FIG. 8.

By planning the colors for the smaller triangles that will eventually form a hexagon at the intersection, the resultant hexagons can either be coordinated to match as another hexagon, or a variety of colors or patterns for example, to form a pinwheel effect.

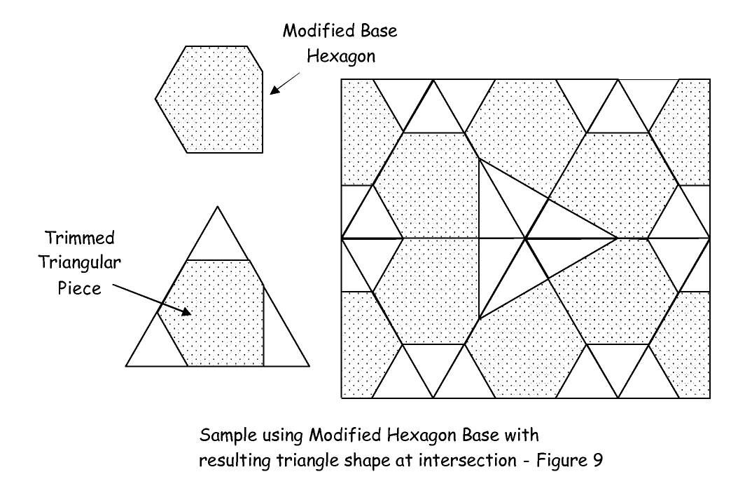

A variation of this method is to alter the shape of the initial hexagon template. By modifying the original hexagon template, but continuing the rest of the method, alternate shapes can be formed at the intersection of the larger triangle pieces. One embodiment of this modification is to alter the hexagon base template so that the resulting intersection shape will be a triangle. See FIG. 9. Another alteration results in a rectangle at the intersection. Yet in each of these modifications, the construction allows for straight stitching without the complication of having to precisely stop and start stitching at a given location.

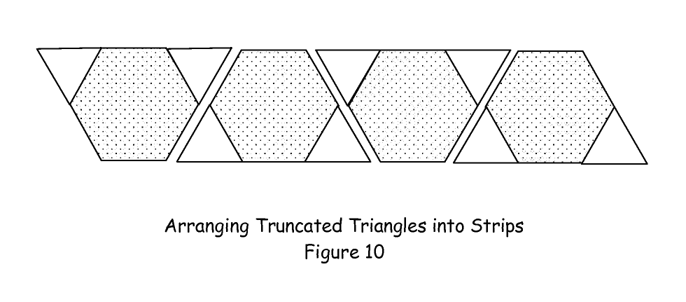

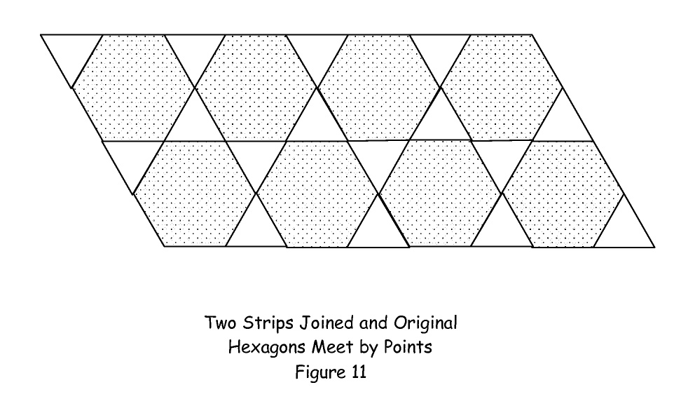

The described method results in the original, intact hexagon shapes being joined together along a common side, as illustrated in FIG. 8. Alternatively, a straight sewing line method can be used to join the original hexagons connected at the points as shown in FIG. 11, by leaving off one of the points of the equilateral triangle and nesting the partial triangles as shown in FIG. 10.

By sizing the paired templates such that the altitude (a straight line from the midpoint of one side to the intersection of the remaining two sides) of the equilateral triangle is equal in length to a standard sized square quilting block, including the seam allowance, it would make it convenient to combine strips of the above described method for mixing hexagon patterns with traditional square quilt designs.

What is claimed is:

1) A pairing of any sized hexagon and equilateral triangle templates in which;
a) the hexagon template has three non-continuous sides that are coincident with the central third of each of the three sides of the equilateral triangle, or
b) two non-continuous sides of a modified hexagon template that are coincident with the central segments of two of the sides of the equilateral triangle where the third non-continuous side of the hexagon template has been altered to accommodate a non-hexagonal pattern at the intersection of the composite triangle pieces, or
c) a composite template with multiple markings that satisfy the above criteria through the use of visible markings on a single template.

2) A method of constructing a hexagon patterned quilt top in which;
a) An equilateral triangular piece is created by combining
(i) a hexagon pattern or,
(ii) a base hexagon with a side that is modified
b) to which additional fabric is added, then trimmed, using a paired equilateral triangle template and;
c) Attaching the triangle pieces to each other in an alternating pattern such that a strip is formed with parallel sides where;
d) The strips can be joined together such that the tips of the equilateral triangles of the adjacent strips are aligned to form a hexagonal shape at the intersections, or alternatively where
e) one corner triangle is omitted from the triangular sewn unit and the truncated units are joined to form strips where the original hexagon shapes are aligned at the points to create variations of designs.

3) The aforementioned method of claim 2 where;
a) The altitude of the equilateral triangle template, that is the dimension from the tip of one point of the triangle to the midpoint of the opposite side, is indexed with standard size quilt blocks, which is typically an integer number of inches for the finished block, plus the standard seam allowance, which is a quarter inch on each side, resulting in altitudes of the equilateral triangle templates that are indexed on the half inch, giving a quarter inch seam allowance on both of the parallel sides of the constructed strip.
